(19) United States
(12) Patent Application Publication
(10) Pub. No.: US 2008/0177662 A1
(43) Pub. Date: Jul. 24, 2008

(54) MOBILE MERCHANT USER INTERFACE

(75) Inventors: Michael Alton Smith, Atlanta, GA (US); Max Glenn Faulkner, Roswell, GA (US); Charles M. Link, Atlanta, GA (US)

Correspondence Address: AMIN, TUROCY & CALVIN, LLP, 1900 EAST NINTH STREET, 24TH FLOOR, NATIONAL CITY CENTER, CLEVELAND, OH, 44114, US

(73) Assignee: CINGULAR WIRELESS II, LLC, Atlanta, GA (US)

(21) Appl. No.: 11/626,763

(22) Filed: Jan. 24, 2007

(51) Int. Cl. G06Q 20/00; G06Q 40/00

(52) U.S. Cl. 705/44; 705/39

(57) ABSTRACT

A merchant is provided the ability to receive and process wireless financial transactions through interaction with a mobile device. The merchant can be authenticated with an account-based service through various techniques including biometric techniques. The merchant can receive a customer's payment information for a sales transaction and input such payment information into the mobile device through various interfaces, such as a keypad, voice recognition, pattern recognition. The mobile device can also include a card reader that can automate entry of the payment information from a credit card, debit card or other identification card.

### CROSS-REFERENCE TO RELATED APPLICATIONS

This application is related to U.S. application Ser. No. 11/608,660, filed Dec. 8, 2006, entitled “MOBILE MERCHANT”.

### BACKGROUND

The mobile telephone industry has been associated with tremendous growth over the last several years. Until recently, mobile telephones were only available to those of highest economic status due to service costs and costs associated with mobile phones. Moreover, network coverage was not extensive enough to enable robust service and only areas associated with dense population were provided with extensive wireless network coverage. The mobile phones that could utilize the networks to communicate were bulky, causing transportation of the phone over any significant distance to be difficult at best.

In contrast, today's mobile devices (e.g., mobile phones, personal digital assistants (PDAs), other suitable user equipment for communication and so forth) can be utilized as full-service computing mechanisms. For example, many of the most recent and advanced mobile devices can be associated with word processing software, web browsing software, electronic mail software, accounting software, and various other types of software. Moreover, mobile devices can be utilized as cameras, video cameras, audio recorders, and the like. Additionally, mobile devices have decreased in both size and cost and modern mobile devices are often small enough to slip into an individual's pocket without discomfort. Furthermore, network coverage has expanded to cover millions, if not billions, of users and many mobile network service providers offer phones and/or disparate devices at extremely low cost to customers who contract for service with such providers.

Many individuals have access to a personal mobile device no matter where that individual may be located (e.g., at home, in the office, while traveling, at a store, and so forth). For those individuals that sell a product, service, or other item, additional equipment must be on hand to complete a sale. Such equipment includes forms and other paperwork to capture payment information (e.g., credit card number), writing devices, credit card reader, and so forth. In addition, the individual might be required to have enough cash on hand to provide change to those customers who are paying by cash.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with a user interface for allowing a user of a mobile device, such as a merchant, to receive payments, issue refunds, or perform other financial transactions with a mobile device. The user interface can provide a productivity-enhancing tool that mitigates the amount of paperwork necessary to perform business transactions. In addition, various timesaving interfaces can allow the merchant, administrators, accounting personnel, etc. to dedicate more time to selling a product or service rather than processing payments.

The merchant can be authenticated or verified as being allowed to process payments through a payment service using various techniques (e.g., fingerprint identification, voice recognition, retina recognition and so forth). The payment information can be input to the device using various techniques (e.g., keypad, voice recognition, pattern recognition, and so on). Such techniques can shorten the time for receiving and processing financial transactions as well as increasing the accuracy of the entered information.

In accordance with some embodiments, merchants have the ability to process customer payments using a mobile device. The merchant can receive a customer's credit card, for example, and enter the credit card information into the device using various techniques (e.g., keypad, voice recognition, pattern recognition). The information can be processed and sent to a server or database that maintains the customer information. The entered information can be reconciled with the server or database allowing the payment to be applied to the merchant account. A payment authentication code or receipt number can be presented to the merchant, through the user device. Such information can be processed utilizing USSD techniques. In addition, the user device can be synchronized, such as with a laptop computer, allowing the merchant to capture the transactions processed with the device.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system for receiving financial transaction information.

FIG. 2 illustrates exemplary user interface display information presented to a user while conducting an account-based financial service.

FIG. 3 illustrates further exemplary user interface display information presented to a user while conducting an account-based financial service.

FIG. 4 illustrates an exemplary user interface device configured for automated receipt of merchant authentication information.

FIG. 5 illustrates an exemplary user interface device for facilitating entry of payment information.

FIG. 6 illustrates a method of providing a merchant various user interface devices to facilitate transactions with an account-based server.

FIG. 7 illustrates a graphical user interface program.

FIG. 8 illustrates an exemplary mobile merchant processing flow.

FIG. 9 illustrates an exemplary computing environment that can be employed in connection with various aspects described herein.

FIG. 10 illustrates an exemplary networking environment.

### DETAILED DESCRIPTION

Various embodiments are described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of example, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

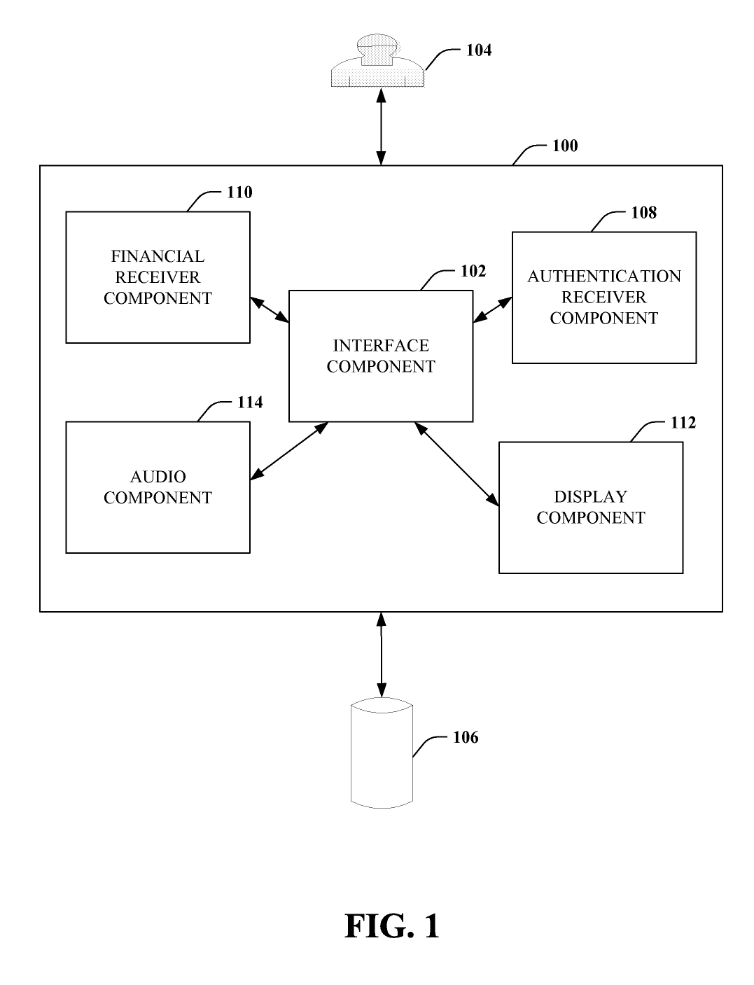

Referring initially to FIG. 1, illustrated is a system 100 for receiving financial transaction information. System 100 can be configured to allow an individual, such as a merchant, to process financial information through utilization of a mobile device, which can be convenient to the user and a customer. In such a manner, the financial information can be processed without additional components (e.g., paperwork to record information) or transfer of cash. System 100 can be implemented on a mobile device, such as a mobile phone, however, it should be understood that other devices can be utilized with the one or more disclosed embodiments. Examples of such devices include smart phones, personal digital assistants (PDAs), computers (desktop and mobile), and other electronic devices both wired and wireless.

In further detail, system 100 can include an interface component 102 that can be configured to interface with a user 104 and with an external database or server 106. The user 104 can be a merchant, salesperson or other person (hereinafter referred to as merchant) that is selling a product, service or performing another transaction with a customer. Examples of such merchants include persons offering products for sale in a home (or other structure) such as through a home demonstration (e.g., cosmetic sales, home decorating products, and so forth), or providing an in-home service (e.g., plumber, appliance repair technician, cable television installer, and the like). The merchant may be offering for sale various items outside a home or structure or at temporary sites, such as selling tickets to a sporting event, air show, craft show, art fair, trade show, and so on. It should be appreciated that a merchant can be accepting payment at a variety of places with or without “wired” authorization capability (e.g., local calling area, roaming area, and so on) for a multitude of consumer purchases.

The server 106 can interact with system 100 through an unstructured supplementary service data (USSD) mechanism that can offer a high-speed, session oriented, menu driven user experience. The USSD technology can allow the user of the mobile device to communicate with other entities (e.g., service provider) in a way that is transparent to the user and the other entities. Server 106 can be a subscriber server that maintains the processing session between the merchant 104 that is receiving payment and an account or payment database, which can be a component of server 106 or associated with server 106 as a third-party server. If the payment database authorizes the transaction, a confirmation code can be provided to complete the transaction. The merchant 104 receiving payment does not need to retain or manually record the payment information (e.g. credit card number, expiration date, owner's signature, and the like) on a sales slip or receipt, thus mitigating the chances of such information being misplaced, stolen, or used for purposes other than the authorized purpose. In some embodiments, the payment transaction can be performed at substantially the same time as a voice call (or other communication exchange) is being conducted with the user device.

A multitude of components can interact with interface component 102 to facilitate authentication of merchant 104 and entry of payment information. For example, an authentication receiver component 108 can be configured to receive information relating to the merchant 104. Such information can authenticate the merchant 104 as an individual authorized to interact with and utilize the account-based server 106 to receive payment from a customer, refund a specific amount to a customer, or perform another financial transaction. The authentication receiver component 108 can comprise biometric functionality, audio functionality, or other functionality. Alternatively or additionally, authentication receiver component 108 can retain the merchant information in a retrievable format, such as a storage medium.

A financial receiver component 110 can be configured to accept or receive payment information. The payment information can include a credit card, debit card number (or other account number) or another identification card, an expiration date of the card, as well as other validation information (e.g., customer zip code). Payment information can further relate to the amount of the transaction, whether the transaction is a payment or a refund, and so forth. The financial receiver component 110 can comprise a card reader that can read a debit card, credit card, or other identification card. In some embodiments, financial receiver component 110 comprises an optical module that can be configured to read payment information directly from the face of the card. The financial receiver component 110 can further be configured to retain financial record information, such as a confirmation code, date, transaction type and amount.

Another component that interacts with the interface component 102 can be a display component 112 that can be configured to display or present the merchant 104 with various menu prompts in order to facilitate entry of authentication information and/or payment information. Such menu prompts can step the merchant 104 through the transaction process in a particular order allowing structured information to be communicated to the server 106 in an appropriate format to mitigate the amount of time necessary to complete the transaction. Display component 112 can further be configured to display a confirmation code or an error message, depending on whether the transaction was processed successfully.

In accordance with some embodiments, the display component 112 can be a graphical user interface (GUI), a command line interface, Natural Language text interface, and the like. For example, a GUI can provide a merchant 104 with a region or means to load, import, select, read, etc. various prompts and/or menu selections, and can include a region to present the results of such prompts and/or menu selections. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The merchant 104 can also interact with the regions to select and provide information through various devices such as a mouse, a roller ball, a keypad, a keyboard, a pen, gestures captured with a camera, and/or voice activation, for example. Typically, a mechanism such as a push button or the enter key can be employed subsequent to entering the information in order to initiate information conveyance. However, it is to be appreciated that the disclosed embodiments are not so limited. For example, merely highlighting a check box can initiate information conveyance. In another example, a command line interface can be employed that can prompt the merchant 104 for information by providing a text message, producing an audio tone, or the like. The merchant 104 can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

An audio component 114 can be configured to interact with interface component 102 to facilitate entry of merchant authentication information and/or payment information. For example, audio component 114 can be configured to provide a speech interface, a Natural Language interface, and so forth, that can provide the ability for the merchant 104 to input the information such as by speaking or audibly entering the information. Such information can be received by audio component 114 and communicated to authentication receiver component 108 and/or financial receiver component 110.

In some embodiments, the customer (not shown) can interact with the audio component 114, display component 112, financial receiver component 110 and/or another component to provide the appropriate payment information. In such embodiments, the merchant 104 may not have knowledge of the payment information, thus, offering added security of the customer's personal information (e.g., bank account number, debit number, credit card number, and so forth) and facilitating business transactions.

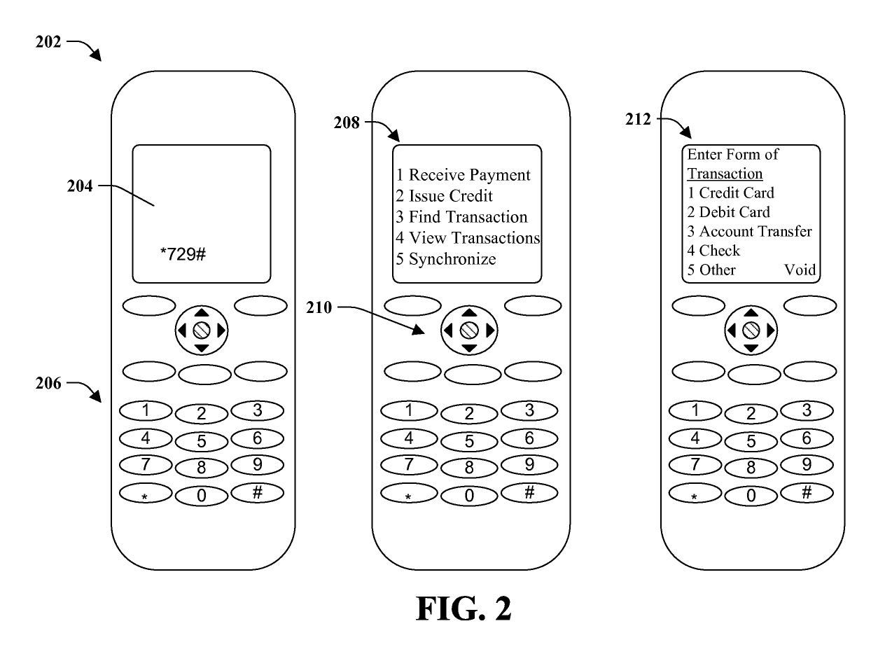

FIG. 2 illustrates exemplary user interface display information presented to a user while conducting an account-based financial service. The displayed information can facilitate structuring the order of the information received from the merchant. The transactions can be performed utilizing a user device (e.g., mobile phone) while mitigating the need for additional components (e.g., a separate credit card reader) or cash transfers.

To initiate an account payment service session or mobile merchant session with an account-based server, a merchant can enter a short code or other information (similar to a telephone number or IP address) into the mobile device 202. It should be understood that while a mobile phone is illustrated, other mobile device can be utilized with the disclosed embodiments. For example, the merchant can enter *PAY#, which is illustrated on a display area 204, as *729#, which represents the entered numbers. The number, code or other invocation can be entered thorough an alphanumeric keypad 206. In some embodiments, a single digit or button on the mobile device 202 can be pressed to initiate the session. In some embodiments, a voice recognition system can be utilized for session initiation whereby the merchant simply directs or instructs the mobile device 202 to initiate communication by stating the intent “initiate account session” or through other invocation statements or natural language statements.

The entered number or code can cause communication to be initiated and the session invocation can be transmitted to the account-based server. The account-based server can respond with a prompts and/or menu selections. For example, the account-based server can reply with a request for merchant information (e.g., authentication information). The merchant can input authentication information through interaction with the mobile device (e.g. through keypad 206, a voice activation device, or other means of communicating information) to authenticate such merchant as being allowed to utilize the mobile merchant service.

In some embodiments, the authentication information can be maintained in the user device 202 and transmitted to the account-based server when requested or at substantially the same time as the communication is initiated. Thus, the merchant might not manually input authentication information. The authentication information can be retained in a retrievable format in a storage media (not shown) associated with user device 202. By way of example, and not limitation, the storage media can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of example and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

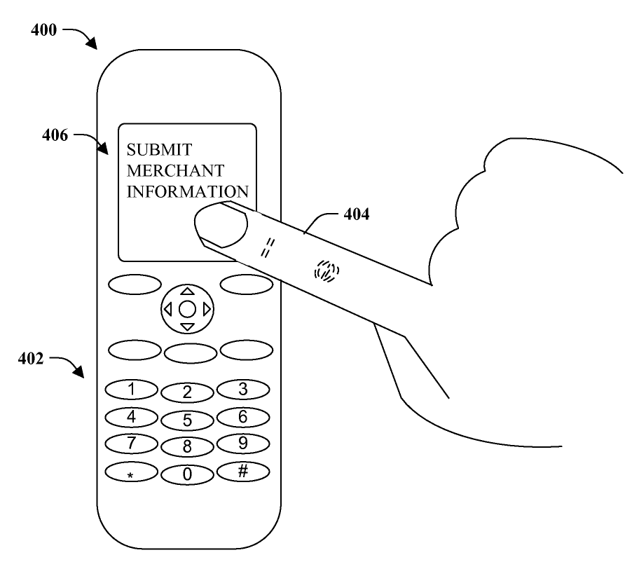

The merchant can also establish an account in order to receive payments and/or issue credits. The authorization to use the service, the valid account, or both can be established before initiation of the communication. For example, the service and/or account can be established directly (e.g., in person, phone call, Internet, . . . ) with the respective service provider. In accordance with some embodiments, either or both the authorization to use the service and the valid account can be established at substantially the same time as the communication is initiated (e.g., the communication does not proceed until such terms and conditions are accepted or the account is established). For example, the authentication component can determine that there is neither a feature code nor a merchant account associated with the user device and transmit a message that includes how to set up such features to the user device 292. Further information regarding entry of merchant information will be provided with reference to FIG. 4 below.

After the merchant has been authenticated, such as if the merchant has both the feature code and the account, a menu (e.g., USSD menu) or various prompts can be presented to the user, through interface component (e.g., a display, audibly, and so forth). Such menu or prompts can be provided by a USSD application that processes requests for the information. The menu or prompts can direct the merchant through a listing of items that should be gathered to process the account payment request. For example, the menu or prompts can request the user to enter payment information through the interface component. A menu selection 208 can be presented to the merchant for selection of an option, such as through utilization of the keypad 206, voice activation, or other means. For example, the merchant can be presented with various options, such as receive payment, issue credit, find a transaction, view transactions, synchronize device, and so forth. Depending on the service desired, the merchant can input the number corresponding to the desired action (e.g., entering “2” in the keypad 206 to issue a credit). In some embodiments, the merchant can request the option through a voice prompt (e.g., “one”, “issue credit” and so forth). Alternatively or additionally, the merchant can scroll through the options using scroll buttons 210 to highlight the selection and then press an enter button or otherwise confirm the selection.

If the merchant proceeds with receiving a payment or issuing a credit, a menu selection can be presented to determine the form of transaction, as illustrated at 212. For example, the transaction can be processed with a credit card, debit card, account transfer, check transfer, or another type of transaction. The merchant can select the type of payment (or credit) by inputting the number corresponding to the number next to the type of transaction or through other means (e.g., voice using natural language). In some embodiments, the merchant can scroll through the selections by using scroll keys 210 (or voice prompts).

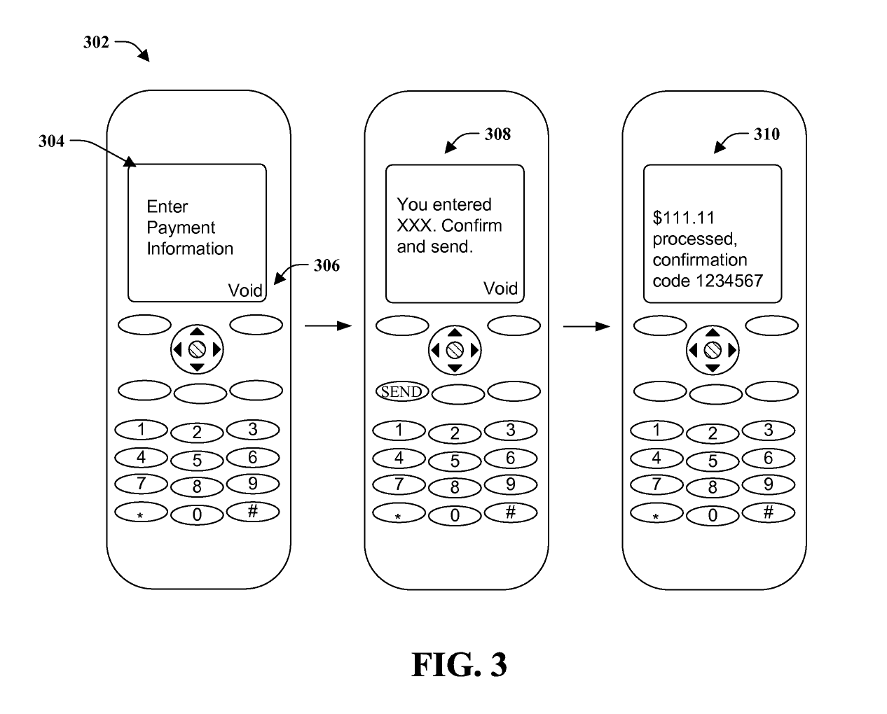

After making the selection, the merchant can be presented with prompts or menu selections to facilitate entry of payment (or credit) information. FIG. 3 illustrates further exemplary user interface display information presented to a merchant while conducting an account-based financial service. Such displayed information can provide a device user (e.g., merchant) to efficiently perform sales transactions and/or other monetary transactions in a timely fashion that is convenient to both the merchant and a customer.

Mobile device 302 illustrates an exemplary prompt for payment information 304. Various prompts or menu selections can be presented to the merchant through a display or other means (e.g., audibly) associated with the device 302. The merchant can respond to the prompts and enter the payment information through interaction with the device 302. Such payment information can be communicated (e.g., wirelessly or through wired means) to account-based server or database. It should be understood that payment transfers (e.g. payment, credit, and so forth) in accordance with the disclosed embodiments can include debit card payments, credit card payments, bank or money transfers, third-party accounts (e.g., PayPal transactions, or the like) or other forms of payment and/or credit. If an error is made or the transaction should be cancelled, an optional void 306 can be provided to void or cancel the entire transaction or a sub-portion of the transaction (e.g., cancel payment information and start again).

Entry of payment information can be based upon prompts and/or menu selections presented to the merchant (e.g. visibly displayed, audible messages, and so forth). The prompts or menu selections can be USSD menu prompts that should be answered for each input of information necessary to verify the payment information. The prompts and/or menu selections can be displayed on a display screen, communicated audibly or through another communication means. Such menu selections can be presented to the merchant based on prompts received from an account-based server, subscriber server, or other server facilitating processing of payment information. Such menu selections 304 can include a type of transaction (e.g., purchase, refund, void transaction, view transactions), amount of transaction, payment method (e.g. credit card, debit card, account transfer, and the like), payment information (e.g., credit/debit card number, expiration date, verification number, card verification value, and so forth). Other menu selections and/or prompts can include request for other payment verification information, such as purchaser's zip code information, telephone number information, or other verification information needed by the account-based server to proceed with the payment transaction. For example, for a credit card payment, the payment information can include a credit card account number, an expiration date, a transaction amount, a credit card verification value, and/or a customer zip code.

The prompts and/or menu selections can be presented to the user individually or at substantially the same time as a response to a previous menu selection and/or prompt is answered (e.g. entered by the merchant), the information is transmitted to an account-based server in an USSD message. If additional information is necessary, a subsequent request can be presented to the merchant.

In some embodiments, a customer can utilize an alias (e.g., an email alias, such as “rickytheman”, “1947robert”, and so forth) that allows the customer to purchase items using the alias and a secret Personal Identification Number (PIN). The payment information can include the customer's alias and the customer can enter the secret PIN directly into the merchant's user device 302, without disclosing such information to the merchant. In some embodiments, the PIN can be received by utilizing an interactive voice response (IVR) system. The IVR system can call the customer on the customer's device (e.g., mobile phone). The customer can confirm by entering (e.g., by Dual Tone Multi-Frequency (DTMF)) their PIN. By using an alias, the customer does not have to share their credit card information (or other payment information) with the merchant. However, in this situation the customer should have their mobile device available in order to complete the transaction. In some embodiments, the payment information can be associated with the customer through an identification means that associates the customer with pre-established payment information (e.g., driver's license, state identification (ID) card, federal ID card, college ID card, library card, frequent shopper card, fingerprint ID, retina ID, speech ID, and so forth).

At substantially the same time that the payment information is received by mobile device 302, the information can be communicated to an account-based database that can return a message 308 to the merchant device 302 to allow the merchant to verify and confirm the payment information. This information can also be communicated audibly or through another communication means. At substantially the same time, the merchant confirms the information, a communication can be sent to the account-based database that can authorize the sale and can credit the merchant account and debit the customer account for a purchase. If the transaction is a refund, the merchant account is debited and the customer account is credited. The debits and/or credits may be applied to the respective account immediately or there may be a delay based on the operating procedure of the particular account holder (e.g., bank).

The merchant can be presented with a confirmation code 310, transaction code or other indicator that can be used to access the payment information, if needed in the future. The confirmation code can be included in an SMS message sent by the account-based database. The SMS message should not include any customer information (e.g., credit card number). For example, the merchant can be presented with a confirmation code and a transaction amount. The merchant can manually write this confirmation code on a receipt (that does not have the payment information thereon) and present the receipt to the customer. In some embodiments, the merchant or account-based database can transmit the confirmation code or SMS message to the customer using a text message or other technique directly to a customer device (not shown). For example, when the customer establishes an account an email alias or other alias for the account-based server or other financial database to automatically forward transaction information (e.g. credit, debit) to the customer utilizing the alias information. Automatically transmitting transaction information can further mitigate unauthorized transactions relating to the customer's account. This real-time feedback can improve sales efficiency and increase successful sales closure rates. The SMS messages can be retained in the mobile device 302, downloaded to a memory device, and the like. The SMS messages can be manually or automatically deleted, such as after a predetermined interval.

If the payment is not authorized, the account-based database can notify the merchant through a visual, audible, or other communication means (e.g., error message). The merchant can determine whether the payment information should be resent (e.g., if it was entered incorrectly) or if the transaction should not be allowed to proceed (e.g., the customer does not have sufficient funds to perform the transaction, the customer is not the owner of the account, and so forth). In such a manner, the merchant can receive payment for the various transactions conducted in a timely manner without having to physically retain the customer's payment information in a hard copy form.

All illustrated, the merchant can be provided an immediate, secure transaction that mitigates the risk of “fat finger” error (e.g., incorrectly collecting data for processing later), mitigates the risk of sale losses from customers who do not want their information manually collected, and mitigates the risk of accepting bad checks (e.g., those with insufficient funds) by offering credit cards or direct bank transfers that can be immediately verified.

FIG. 4 illustrates an exemplary user interface device 400 configured for automated receipt of merchant authentication information. In order to use an account-based service, the merchant should be approved for the service (e.g., has a valid merchant account). Authentication information can authenticate the mobile device 400 (and the user of the device) with a mobile switching center (MSC) or other authentication server or database. As used herein, an account-based server (database) is a repository of account information (both individual accounts and company accounts) that are processed through the account-based server. The accounts can be associated with the account-based server or other entity, provided the account-based server has the capability to access or obtain information regarding such accounts. In some embodiments, the account-based database is a third party merchant that is associated with MSC, such as by sharing services. In other embodiments, the functions of the account-based database and MSC are performed by a single server, database, or entity.

Mobile device 400 can be configured to communicate a USSD message to the account-based server that can include merchant authentication information. The access to a financial service offered by the account-based server might be based on whether the merchant has signed-up for such a service or accepted terms and conditions relating to the service. If the merchant has access to the service, a feature code may be assigned to the mobile device 400 and/or to the merchant. The authentication information can facilitate processing and receipt of customer payments into a merchant account or to refund a customer from the merchant account. The authentication information can be included in an USSD message and can include various types of information (e.g., authentication, feature code, merchant account, and so forth) relating to the user device 400. In some embodiments, the merchant may have a prior relationship with an account-based service. In other embodiments, the merchant can establish a relationship and receive authentication information at substantially the same time as the communication is initiated. For example, if the user device is not associated with a feature code and a merchant account, a USSD message can be received at the user device indicating that the user device could not be authenticated and the merchant may be provided the opportunity to establish an account to utilize the service.

The authentication information can be input manually, such as by entering the information into a keypad 402 or audibly entering the information (e.g., natural language). As illustrated, the merchant authentication information can be input automatically through various techniques (e.g., biometrics). As illustrated, a merchant can pass a finger or thumb 404 over an input area 406 or simply present the finger or thumb 404 to an input area 406. It should be understood that while the input area 406 illustrated is substantially the same as a display that presents information to the merchant, the input area 406 can be placed at a different location on the mobile device 400 and may be a different configuration. Alternatively or additionally, a retina scan can be utilized rather than a fingerprint or thumbprint 404, as illustrated. In some embodiments, voice recognition software can be utilized.

The authentication information might associate a particular individual with a particular company account if that individual is employed by such company, thus the merchant account does not have to be a personal account. The authentication information can include a personal identification number (PIN) or other number, or other identification means. An unique number (e.g., telephone number) associated with the user device 400 may also be communicated at substantially the same time as the PIN.

In some embodiments, user device 400 can include a biometric functionality authenticating a merchant to allow such merchant to process customer payments. Upon successful entry and confirmation of the merchant authentication code (or receipt of the biometric information), the merchant can be presented with a second display having a drop down selection menu that presents various options (e.g. enter payment information, view previous transactions, void a transaction). The merchant can also be presented with a screen allowing entry of a sales dollar amount, a credit dollar amount, or other information including notes (e.g., credit applied with 50% restocking fee). Confirmation information can be presented to the merchant along with a code or other identifying techniques. In some embodiments, the biometric functionality or other identifying functionality can be used with respect to automatically identifying a customer and/or merchant.

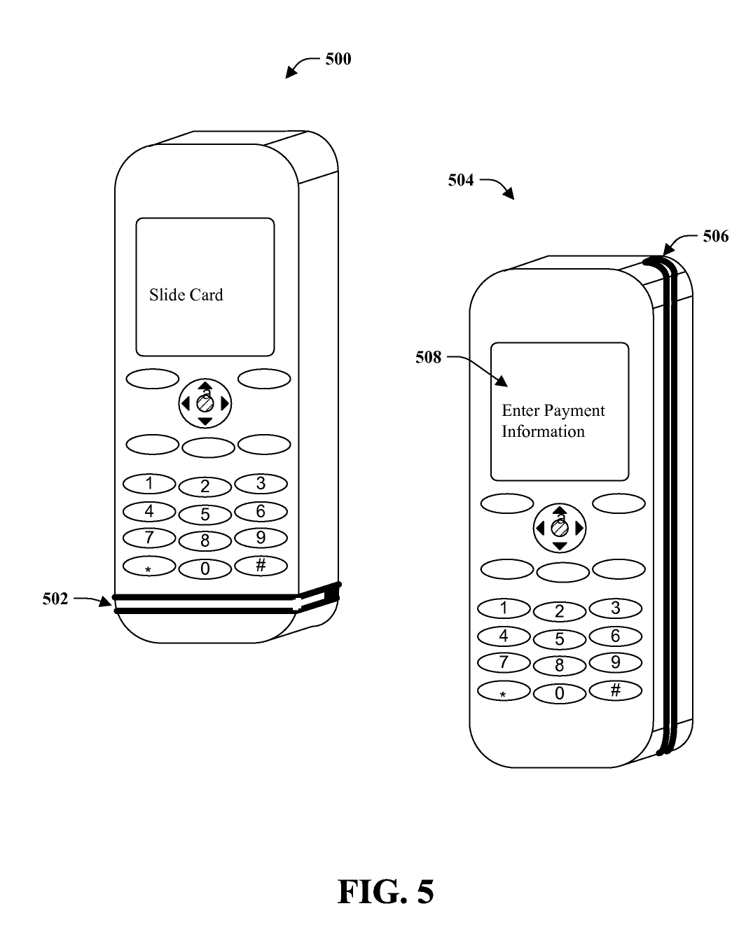

FIG. 5 illustrates an exemplary user interface device 500 for facilitating entry of payment information. In order for the transaction to be processed correctly through the account-based service, the correct payment information should be input. The merchant can enter customer payment information through interaction with the device 500. Such payment information can be communicated in a USSD message to an account-based server that can apply the proper payment to the correct merchant account and debit such amount from the customer account.

Various user interfaces can be presented to the merchant to enter customer payment information (e.g., credit card number). For example, a merchant can be presented with a display screen prompting for the payment information or audibly guiding the merchant through the transaction processing. The merchant can enter the information into a keypad or audibly into an audible component.

In some embodiments, the payment information can be automatically captured by a mobile device 500. Included with mobile device 500 can be a slide 502 (e.g., card reader) through which a magnetic strip of a credit card and/or debit card can be passed to automatically capture the credit card information. The card can be passed through the reader upon receipt of a prompt (e.g., “slide card”, “enter payment information”). Thus, mobile device 500 can provide a dual functionality; the functionality is the capability of the device 500 (e.g., phone calls) and credit card reader functionality.

The slide through which the card is passed can be located anywhere on the mobile device 500. The slide 502 can be located near the bottom front of the mobile device, as illustrated. Mobile device 504 illustrates a slide 506 located on the side of the device 504. However, a card slide can be located anywhere on the device and the locations illustrated are for example purposes only.

In some embodiments, a screen 508 of a mobile device 500 can be utilized to capture an image of a card, such as by presenting the face of the card to an input screen 508 of the device 500. The captured image can be analyzed and the card numbers read and input automatically. In some embodiments, a screen separate from the display screen 508 can be provided for reading the card and/or receiving authentication information (e.g., driver's license, other identification).

In some embodiments, RFID technology can be utilized whereby the merchant mobile device can capture card information at a distance (e.g. admission for an event). This can be possible where the credit card is configured to transmit such credit card information, such as through a passive or active RFID chip.

In view of the exemplary systems shown and described above, methods that may be implemented in accordance with the disclosed subject matter are provided While, for purposes of simplicity of explanation, the methods are shown and described as a series of blocks, it is to be understood and appreciated that the disclosed embodiments are not limited by the number or order of blocks, as some blocks may occur in different orders and/or concurrently with other blocks from what is depicted and described herein. Moreover, not all illustrated blocks may be required to implement the methods described hereinafter. It is to be appreciated that the functionality associated with the blocks may be implemented by software, hardware, a combination thereof or any other suitable means (e.g. device, system, process, component). Additionally, it should be further appreciated that the methods disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

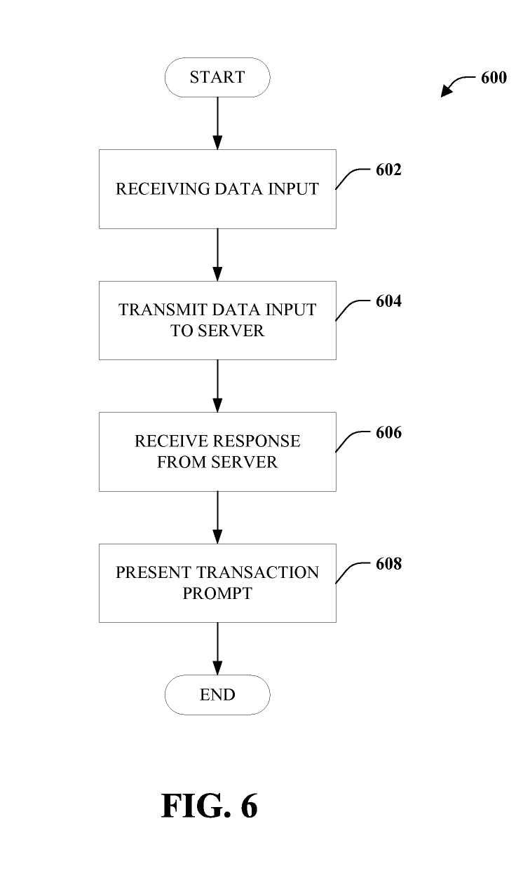

FIG. 6 illustrates a method 600 for providing a merchant various user interface devices to facilitate transactions with an account-based server. Method 600 starts, at 602, when data input is received. The data input can be a communication initiation request, merchant authentication information and/or customer payment information. The communication initiation request can be a code or number that can invoke a communication with an account-based server in order to process monetary transactions. The merchant authentication information can be utilized by the account-based server to match a particular merchant with a merchant account. The payment information can include customer account information. The payment information in conjunction with the merchant authentication information can facilitate credits and/or debits to the appropriate accounts (e.g., merchant account, customer account).

At 604, the data input is transferred to a server, such as an account-based server that provides mobile merchant services. For example, a communication initiation request can be transmitted to the server to begin a mobile merchant service session. If the data input is merchant authentication information, the server can verify whether the merchant is authorized to use the service. If the customer payment information is transmitted, the server can verify whether there are funds in the customer's account to complete the transaction, for example.

Depending on the data input transmitted, the server can respond, at 606, with menu selection or prompt information that can be presented (e.g., visual, audio, and so forth) to the merchant, at 608, to structure the order of the data input. For example, if the server receives a communication initiation request, a menu prompt can be presented to the merchant to enter merchant authentication information. If the server receives information relating to authentication information, a menu selection can be presented to the merchant to enter payment information in a particular order such as transaction type, account type, amount, and so forth. Communication of payment information can return a prompt or information relating to confirmation (e.g., a confirmation code) or denial of the transaction (e.g., error message). In some embodiments, the confirmation code and/or error message can be transmitted to a customer device.

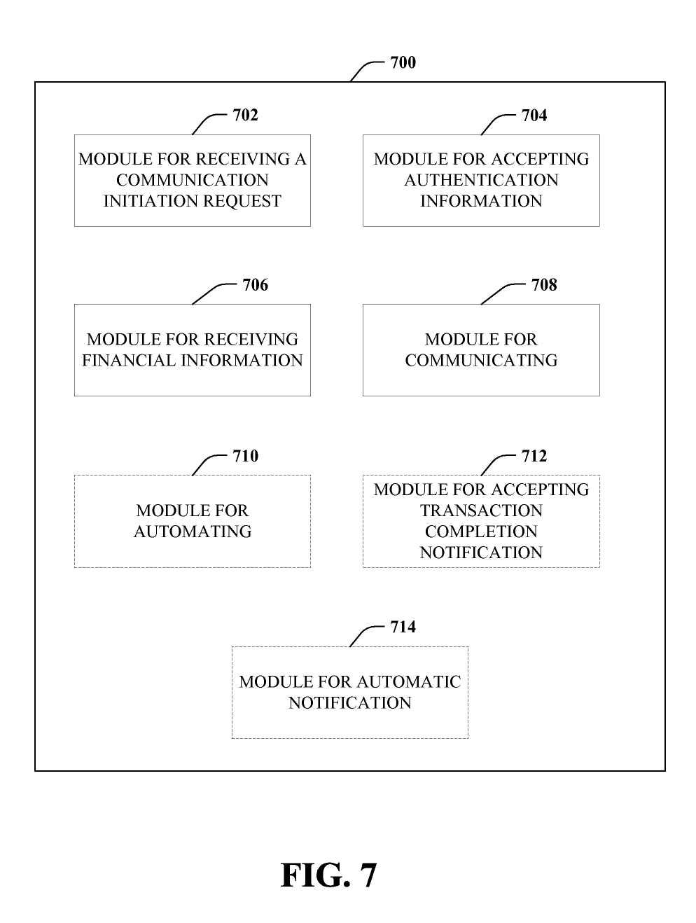

FIG. 7 illustrates a graphical user interface program 700. The program 700 can be embodied on a computer-readable medium associated with a mobile device. The program 700 is represented as modules, which can be functional blocks that represent functions implemented by a processor, software or combination thereof (e.g., firmware). Included in the program 700 is a module for receiving a communication initiation request 702. The communication initiation request can be entered manually, such as through a keypad, audibly, such as through natural language commands, or through other functionality.

A module for accepting authentication information 704 can include biometric functionality, visual functionality and/or audible functionality for accepting merchant authentication information. Additionally or alternatively, module for accepting authentication information 704 can be associated with a storage media for maintaining the authentication information in a retrievable format to mitigate the merchant from entering the information each time the mobile merchant service is accessed. Also included in program 700 is a module for receiving financial information 706, which can include audible functionality, visual functionality, or automatic acceptance of financial information, such as with a card reader.

Also included in program 700 is a module for communicating 708 at least one of the communication initiation request, authentication information or financial information to an account-based server. The module for communicating 708 can transmit the initiation request to a server, such as a server that provides a mobile merchant service, to invoke the mobile merchant service. The authentication information can be automatically transmitted by the module for communicating 708 at substantially the same time the initiation request is sent to the server. In some embodiments, the module for communicating 708 transmits the authentication information after receipt of a specific request from the server or the module for communicating 708 can communicate the financial information to the server after the server approves the merchant as being an individual authorized to access the mobile merchant service. The module for communicating 708 can send the financial information to the server as a single message or can sub-portion the financial information and send one or more sub-portion of the information in different messages.

In some embodiments program 700 further includes a module for automating 710 at least one of the module for accepting authentication information 704 or the module for receiving financial information 706. Automation can provide accuracy in the entered information and can include biometric functionality, audio functionality, visual functionality, or other functionality for automating information input.

The server can respond with a communication code, indicating that the financial transaction has been processed successfully, or an error message, indicating that there was an error in processing the transaction. Both the confirmation code and the error message can be a transaction completion notification, which can be received by a module for accepting the transaction completion notification 712. A module for automatic notification 714 can be configured to automatically notifying a customer of the at least one of the confirmation code or the error message. Such notification can be sent to the customer's mobile device, a customer email alias, or another identified recipient type.

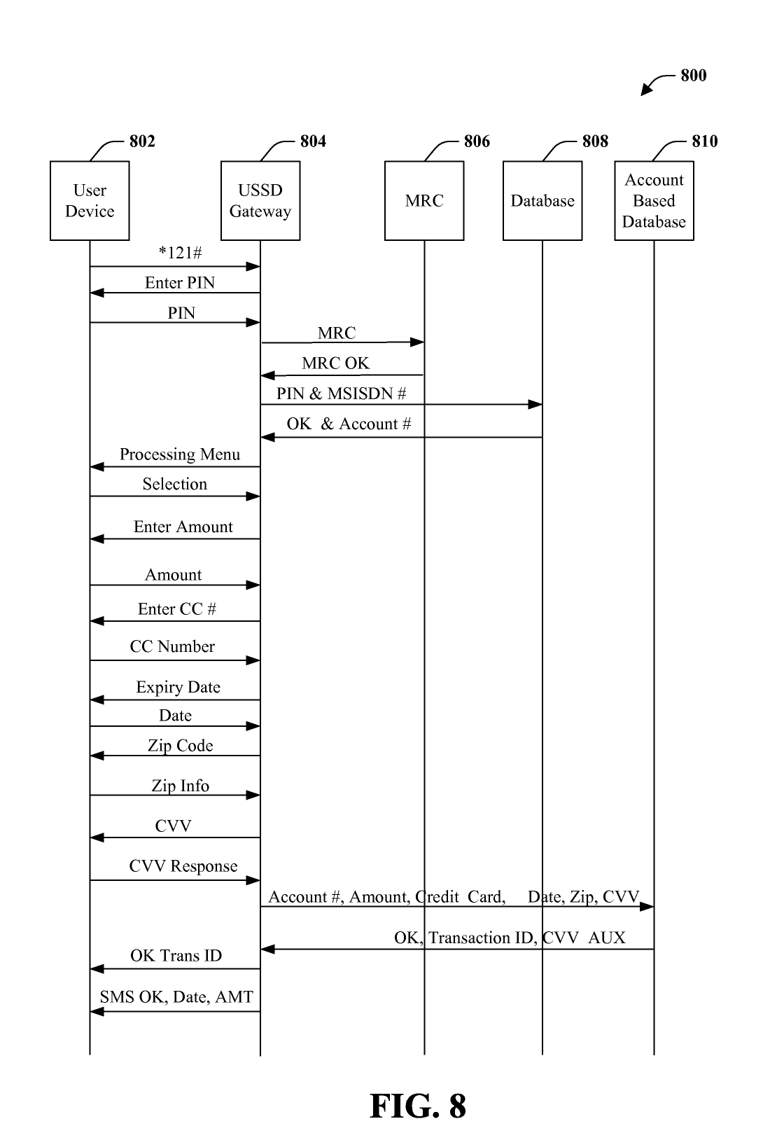

With reference now to FIG. 8, illustrated is an exemplary mobile merchant processing flow 800. A communication is initiated from a user device 802, such as by entering a short code (e.g., *121#). However, it should be understood that the communication can be initiated utilizing a different code, number, or technique. The communication initiation request is received at a USSD Gateway 804, that can respond with a request for information that authenticates the user device 802 (e.g., “enter PIN”). The request can be displayed on a display screen of the user device 802, or it can be presented to the user as an audible request, or through another technique. The PIN or other authentication information can be entered using a keypad of user device 802, through voice recognition, or through another means that can interpret and send the information in a format understandable by the USSD Gateway 804.

The USSD Gateway 804 can send a communication request (“MRC”) to an MRC 806, which can respond with an indication to proceed with the communication (“MRC OK”). A PIN and a unique number associated with the user device 802 can be sent to a database 808, such as an MRC database, to determine if the user device 802 is authorized to use a mobile merchant service. Such determination can be made based on whether a feature code or Monthly Recurring Charge is available for (e.g., assigned) that user device 802. For example, the feature code and/or Monthly Recurring Charge can be cross-referenced with the PIN and unique number associated with the user device. If the user device 802 is authorized to use the service, database 808 replies to the USSD gateway 804 with a confirmation. If the user device 802 is not authorized, database 808 can respond with an error message or other message indicating that the transaction cannot proceed

Upon receipt of the confirmation, USSD gateway 804 can request various types of information that relate to processing the payment, credit or other transaction. Such requests can be presented in the form of a processing menu that can be displayed on the user device. However, it should be understood that other techniques of facilitating communication of the payment information can be utilized with the disclosed embodiments. The type of transaction (e.g., payment, refund, and so forth) can be selected and the USSD Gateway 804 can prompt for further information such as the amount of the transaction, a credit card number, expiration date, zip code, credit verification value, and so forth. Responses to each request can be sent from the user device 802 to the USSD Gateway 804. Such response may be received before a next request for information is sent.

Once the necessary data is collected, the USSD Gateway 804 communicates the information to an Account-Based Database 810. The information received can be verified by the account-based database 810 to ensure that the information matches a valid account. If valid, a confirmation is sent to the USSD Gateway 804 to proceed with the transaction. The USSD Gateway 804 can send a confirmation and a transaction identifier to the user device 802. A terminating USSD message can be sent at substantially the same time as an SMS message that includes an authorization code, date of transaction, amount of transaction, and/or other information relating to the processed transaction is sent. The SMS message can be retained in storage media associated with the user device 802.

If the account was not verified by the account-based database 810, an error message or other message can be sent to the USSD Gateway 804. The user device 802 can be notified that the entered information was incorrect, that there are insufficient funds to process the transaction or that the transaction cannot be completed based on other factors. In such a manner, the merchant receives real-time communication regarding the transaction and can mitigate non-payment if the customer payment is not processed. For example, the merchant can notify the customer that the payment was not authorized. The customer can decide to use another form of payment and/or the merchant/customer can decide to not proceed with the transaction.

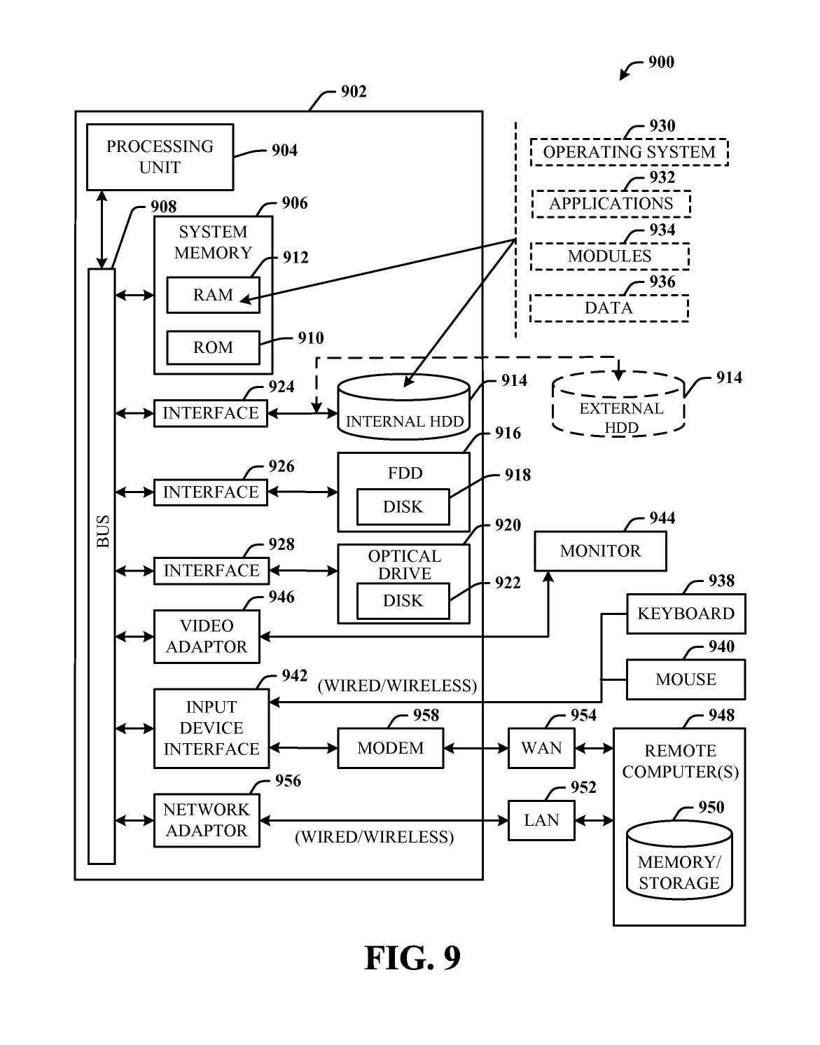

Referring now to FIG. 9, there is illustrated a block diagram of a computer operable to aid in provisioning of dual mode services as described above. In order to provide additional context for various aspects, FIG. 9 and the following discussion are intended to provide a brief, general description of a suitable computing environment 900 in which the various aspects described herein can be implemented. While the description above is in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the various embodiments can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the embodiments may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g. EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that the innovation can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 may operate in a networked environment using logical connections through wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g. a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from home, in a hotel room, or at work, without wires. WiFi is a wireless technology similar to that used in a cell phone that enables such devices, e.g. computers, to send and receive data indoors and out; anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

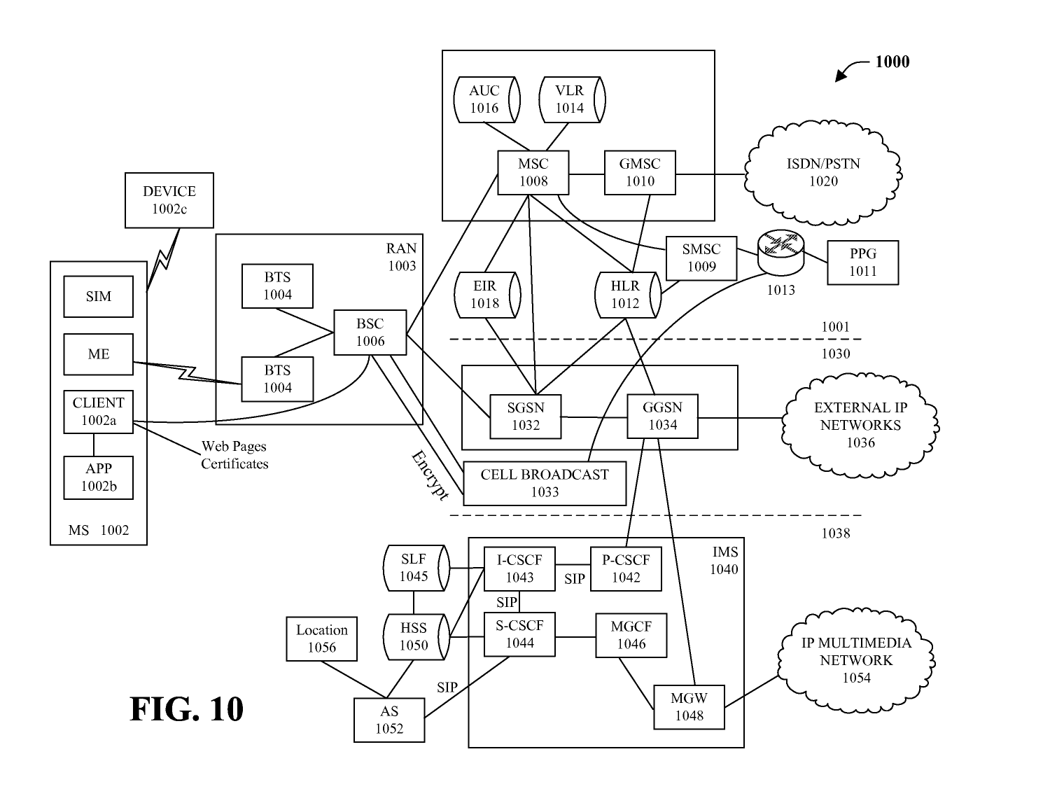

Now turning to FIG. 10, illustrated is a GSM/GPRS/IP multimedia network architecture 1000 that includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber Identity Module (SIM). The SIM includes an International Mobile Subscriber Identity (IMSI), which is a unique identifier of a subscriber. The MS 1002 includes an embedded client 1002a that receives and processes messages received by the MS 1002. The embedded client 1002a may be implemented in JAVA and is discuss more fully below.

The embedded client 1002a communicates with an application 1002b that provides services and/or information to an end user. One example of the application may be mobile merchant software that provides real-time payment transaction information that is received by the embedded client 1002a to the end user. The mobile merchant software may provide availability of a mobile merchant service, status or confirmation of a payment transaction, etc. based on information received from the MS 1002.

Alternatively, the MS 1002 and a device 1002c may be enabled to communicate through a short-range wireless communication link, such as BLUETOOTH. For example, a BLUETOOTH SIM Access Profile may be provided in an automobile (e.g., device 1002c) that communicates with the SIM in the MS 1002 to enable the automobile's communications system to pull information from the MS 1002. The BLUETOOTH communication system in the vehicle becomes an “embedded phone” that employs an antenna associated with the automobile. The result is improved reception of calls made in the vehicle. As one of ordinary skill in the art would recognize, an automobile is one example of the device 1002c. There may be an endless number of devices 1002c that use the SIM within the MS 1002 to provide services, information, data, audio, video, etc. to end users.

The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1016, and an Equipment Identity Register (EIR) 1018. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. In other words, the GMSC 1010 provides interworking functionality with external networks.

The HLR 1012 is a database or component(s) that comprises administrative information regarding each subscriber registered in a corresponding GSM network. The HLR 1012 also includes the current location of each MS. The VLR 1014 is a database or component(s) that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (e.g., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. It is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, through the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 1033 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time. A class B MS can attach to the network for both GPRS services and GSM services simultaneously. However, a class B MS does not support simultaneous operation of the GPRS services and GSM services. That is, a class B MS can only use one of the two services at a given time. A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while received data and vice versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043 forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSSs 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

What has been described above includes examples of the disclosed embodiments. It is, of course, not possible to describe every conceivable combination of components or methods for purposes of describing the embodiments, but one of ordinary skill in the art may recognize that many further combinations and permutations of such matter are possible. Accordingly, the embodiments are intended to embrace all such alterations, modifications and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A user interface to collect and manage a plurality of monetary transactions, comprising:
an authentication receiver component that accepts user authentication information;
a financial receiver component that receives payment information; and
an interface component that communicates the authentication information and the payment information to a remote server.

2. The system of claim 1, further comprising a display component that presents a plurality of menu selections to the user.

3. The system of claim 1, the authentication receiver component comprises biometric functionality.

4. The system of claim 1, the financial receiver component comprises a card reader.

5. The system of claim 1, the card reader reads at least one of a credit card, debit card or identification card.

6. The system of claim 1, the financial receiver component comprises an optical module configured to read payment information.

7. The system of claim 1, the authentication receiver component and the financial receiver component comprising audio functionality.

8. The system of claim 1, further comprising a display component that displays at least one of a confirmation code acknowledging completion of the monetary transaction or an error code indicating the monetary transaction could not be completed.

9. The system of claim 1, the financial receiver component automatically discards the payment information upon completion of the monetary transaction.

10. The system of claim 1, the financial receiver component retains transaction information in a retrievable format.

11. The system of claim 1, the authentication receiver component stores the user authentication information in a storage media.

12. A method of processing financial transactions with a remote device;
receiving a data input relating to a financial transaction;
transmitting the received data input to a server;
receiving a communication from the server in response to the transmitted data input; and
presenting a transaction prompt to structure the order of the data input

13. The method of claim 12, receiving a data input relating to a financial transaction comprising accepting keypad entry information.

14. The method of claim 12, receiving a data input relating to a financial transaction comprising accepting biometric merchant information.

15. The method of claim of claim 12, receiving a data input relating to a financial transaction and presenting a transaction prompt comprising utilizing audio functionality.

16. The method of claim 12, further comprising:
receiving at least one of an error message or a confirmation code from the server; and
automatically sending a notification to a customer device, the notification includes the error message or the confirmation code.

17. A graphical user interface program, comprising:
means for receiving a communication initiation request;
means for accepting authentication information;
means for receiving financial information; and
means for communicating at least one of the communication initiation request, authentication information or financial information to an account-based server.

18. The graphical user interface program of claim 17, further comprising means for automating at least one of the means for accepting authentication information or the means for receiving financial information.

19. The graphical user interface program of claim 17, further comprising means for accepting at least one of a confirmation code or an error message.

20. The graphical user interface program of claim 19, further comprising means for automatically notifying a customer of the at least one of the confirmation code or the error message.
